(19) United States
(12) Patent Application Publication
(10) Pub. No.: US 2008/0114735 A1
(43) Pub. Date: May 15, 2008

(54) Systems and methods for managing information

(76) Inventors: Peter Salemink, Pretoria (ZA); Christiaan Emile Pretorius, Pretoria (ZA)

Correspondence Address: FOLEY AND LARDNER LLP;SUITE 500, 3000 K STREET NW, WASHINGTON, DC, 20007, US

(21) Appl. No.: 11/905,168

(22) Filed: Sep. 27, 2007

Related U.S. Application Data
(60) Provisional application No. 60/848,032, filed on Sep. 29, 2006.
(60) Provisional application No. 60/924,983, filed on Jun. 7, 2007.

(51) Int. Cl. G06F 17/30

(52) U.S. Cl. 707/3

(57) ABSTRACT

Systems and methods for application programming and data storage and retrieval are disclosed. The systems and methods relate to an application programming system that is comprised of a plurality of dynamic distributed objects, each preferably having a child register and parent register. The dynamic distributed objects are preferably organized into nodal networks comprising two layers and interact with each other and a service to form an application. The service application is preferably loosely coupled and dynamically alterable. Systems and methods also relate to indexing features of the application programming system.

### CROSS REFERENCE TO BENEFIT APPLICATIONS

This application is related to and claims the benefit of U.S. provisional application No. 60/848,032, entitled “SYSTEMS AND METHODS FOR MANAGING INFORMATION” filed Sep. 29, 2006, the contents of which are hereby incorporated by reference. This application is also related to and claims the benefit of U.S. provisional application No. 60/924,983, entitled “SYSTEMS AND METHODS FOR THE RETRIEVAL OF DISTRIBUTED INFORMATION” filed Jun. 7, 2007, the contents of which are hereby incorporated by reference.

### BACKGROUND OF THE INVENTION

As the volume of information available to businesses and individuals continues to expand, the usefulness of that information becomes limited by the ability to retrieve the correct information at the correct time. Large collections of data, such as might be generated by a government agency, a multinational corporation, an insurance company, etc. strain the limits of current relational database technology. The present application is therefore directed to technology for the fast and efficient retrieval of large amounts of information.

Because relational databases rely on the separation of the data and business layer of the application, the data is stored in a manner largely independent of associations and relationships between different data elements. For this reason associations and relationships are “discovered” during use using keyed lists. Each time a related piece of information is required, a lookup through lookup lists needs to be performed.

An example of a prior art relational database structure 800 is shown in FIG. 8. FIG. 8 shows how information in relational databases is stored in tables 802 and 804, each of which has an index column with several index entries, including 806 and 812, respectively. Each row has data entries, for example entries 808 and 810. To choose a simple application, a bookstore might operate a database with a table (e.g. table 802) called “books,” where the index is the ISBN (e.g. index 806), and the field entries are “Author” and “Price” (e.g. data values 808 and 810). A second table might be entitled “books in inventory” (e.g. table 304), where the index field a randomly generated key (e.g. index 30), and the fields are the ISBN and “location on shelf.” In this way, where there are multiple copies of the same book in inventory, the author and the price can be stored separately and not repeated in the table “books in inventory.”

This setup for relational databases requires the searching of lookup lists in order to find relevant data. For large extremely large data collections, the manner of addressing and the limit of the length of these lookup lists limits the number of data pieces that can be referenced in this way. There are some “work-arounds,” however, these are only delaying the approach of a limit which is presently being pressed.

The fact that databases rely on lookup lists means that simple (uni-dimensional) searches have a computational complexity of alog(n) where n is the number of data elements and “a” is a constant. That is, the amount of effort required to perform a simple searches increases as alog(n) as the number of data elements increases. More complex searches, e.g. a two dimensional search would have complexity of (alog(n))². If the number of data elements in this example increases ten fold, then time to compute the result will increase by over 50 fold.

As a particular example, when a conventional application system stores information, it must have a way of finding and retrieving the information again. This is often done with a database structure. The normal manner of information lookup is by either sequential searching or, if the look-up parameter (key) is indexed, by searching through a b-trieve structure. Sequential searching involves sorting through a list structure and comparing stored information with a search target. A b-trieve structure typically involves the formation of hash tables that allow faster access into sequentially stored data. The best time-complexity for the retrieval of information with such structures is then time(n)=k log n.

The overall architectural limit, that is the limit on the size of information imposed by the architectural structure of relational databases at which a business system can reasonably perform, is currently estimated to be at about 10¹⁷ Bytes of information.

### SUMMARY OF THE INVENTION

Certain embodiments of the invention relate to a method for storing data for retrieval, comprising the steps of: determining a search key for the data; partitioning the search key into discrete subelements; creating an object for each subelement; attaching the respective object for each subelement to its nearest neighbor in the search key to form a chain of attached objects; and attaching an object containing the data to the last subelement of the search key. Such a method may further comprise attaching at least one index object as a child to an object comprising a discrete subelement, and may be implemented such that each index object has a direct parent object, and wherein each index object comprises a list having one or more entries, each entry representing an object that is attached as a child object to the direct parent object.

Other embodiments of the invention relate to a system, comprising: at least one processor unit including a processor for executing code and a memory space; the processor unit having access to a plurality of objects; wherein the plurality of objects forms a chain of objects attached to one another and comprising a search key, and wherein one object in the chain comprises a data element identifiable by the search key. The system optionally comprises a plurality of processor units wherein the objects are distributed among the processor units. The system can be implemented so that each processor unit comprises non-volatile storage; and wherein each object comprises a reference to its own storage location in the non-volatile storage.

Still other embodiments of the invention relate to a method for retrieving data, comprising the steps of: receiving a search key for the data; partitioning the search key into discrete subelements; following a chain of child objects matching the discrete subelements in order; and retrieving the data in an object ultimately attached to an object comprising the last discrete element of the search key. The method optionally comprises using at least one index object attached as a child to an object comprising a discrete subelement.

Further embodiments of the invention relate to a method for the organization of at least part of an application, comprising: providing a plurality of dynamic distributed objects that comprise executable code; providing, for each of the plurality dynamic distributed objects, a parent object register and a child object register within each object; and providing a nodal layer and an information layer for storing the plurality of dynamic distributed objects. The method may be implemented such that for the plurality of dynamic distributed objects, the nodal layer and the information layers have symmetrical nodal structures. Additionally, the step of providing a plurality of dynamic distributed objects that comprise executable code may further comprise providing dynamic distributed objects that comprise flags and inherent methods.

Other embodiments of the invention relate to a system, comprising: at least one processor unit including a processor for executing code and a memory space; the processor unit having access to a plurality of dynamic distributed objects; wherein the plurality of dynamic distributed objects forms two nodal layers that are symmetric in their nodal structure. The system may additionally be implemented such that each of the plurality of dynamic distributed objects comprises a parent register and a child register and each of the plurality of dynamic distributed objects includes flags and inherent methods.

Still other embodiments of the invention relate to a method for managing an application stack comprising: providing a plurality of application services in a stack; providing access to each application service through an interface; and replacing the code for an application service during execution of the application stack. Further, the method may be carried out so that the application stack is a service to a second application formed of a plurality of dynamic distributed objects.

Further embodiments of the invention relate to a system, comprising: at least one processor unit including a processor for executing code and a memory space; the processor unit having access to a plurality of dynamic distributed objects; wherein the processor unit executes a service that comprises code for at least two application services; wherein the at least two application services are accessed through an interface; and wherein the service provides application services to a second application formed of a plurality of dynamic distributed objects

### BRIEF DESCRIPTION OF THE DRAWINGS

FIG. 1 shows an index tree according to an embodiment of the invention.

FIG. 2 shows an index tree according to an embodiment of the invention.

FIG. 3 is a flow chart according to a method embodiment of the invention.

FIG. 4 is a flow chart according to a method embodiment of the invention.

FIG. 5 is a multiprocessor system diagram according to a system embodiment of the invention.

FIG. 6 shows an application nodal layer structure according to an embodiment of the invention.

FIG. 7 shows a typical structure of a dynamic distributed object of a preferred embodiment of the invention.

FIG. 8 is a prior art description of a relational database.

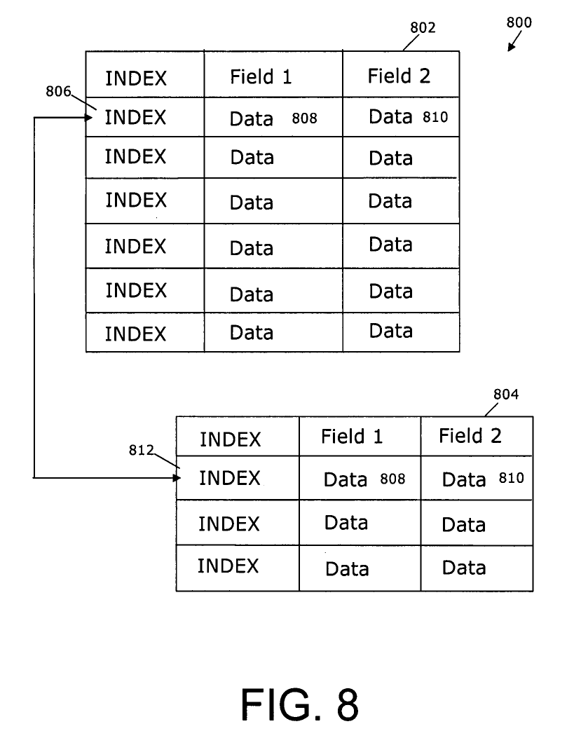

FIG. 9 illustrates a virtual stack in accordance with preferred embodiments of the invention.

### DETAILED DESCRIPTION OF EMBODIMENTS

The present application relates to, among other things, a system for the management and distribution of symmetric dynamic objects over a distributed system. The “system” as described herein is generally a computer system, that may be distributed over a communications system. This system preferably comprises the one or more communications networks, computer hardware, and computer software.

Relational databases are currently used both for data storage and retrieval as well as object storage and retrieval during the execution of object oriented applications, such as those written in C++. An improvement in information storage and retrieval impacts therefore not only on the speed, efficiency and robustness of information systems, but also on the speed, efficiency and robustness of software applications.

Embodiments of the present invention concern themselves therefore not only with an efficient data storage and retrieval system, but also with an application programming system. In particular, embodiments of the present invention deal with computer software and the interface of computer software with hardware. The software may be embedded in a memory, including a non-volatile storage type such as a disk, such that it can be executed by a processor. Such software as contemplated in embodiments of the present invention comprises dynamic distributed objects which are interoperative to form both the structure of an application and the data repository. Such systems preferably operate with object structures that are classless but can change their structure dynamically at runtime.

Typically, the word “object” has been both been used broadly to describe a group of data and/or code having a discrete boundary, as well as in specific contexts a “class” or definition of a group of code or data, from which actual copies (“instances”) can be defined. In the present context, the term “object” has its broad meaning. The objects as used in application programming and database systems relevant to the present embodiments preferably do not have classes or archetypal definitions (or such are limited) and are modifiable in their structure during execution of an application which each object forms a part. Such objects, by their nature, are easily usable in a distributed fashion (although it is not necessary that either the dynamism or distribution actually be implemented). We will therefore refer to such objects where appropriate as “dynamic, distributed objects” or “DDOs” to highlight the preferred features of these objects and to distinguish them from class-based objects.

In the case of dynamic distributed objects, data can be directly accessed (as opposed to through a database structure) and therefore the retrieval time can be converted into a linear sub-linear space complexity and a sub-linear retrieval complexity by the use of index trees. In this way a single additional overhead incurred at the time of storage of the data record reduces the complexity of retrieval. Further, the complexity of the data storage referred above is also sub-linear in time complexity.

DDOs are preferably individual data structures that have relationships to neighbor data structures. They can therefore be envisaged as nodes on a grid. The grid may be distributed over a network on a large number of computing systems. In preferred embodiments, each DDO comprises pure data, software code or both, and relates to other DDOs. An interaction manager application running on each computing system executes DDO code to the extent it is called for in an application. This interaction manager is sometimes called a “service” in this document, because it provides “application services” such as persistence and communication to DDOs operating on a particular platform. Application services are thus software components that provide a function to another software component, such as an application formed by DDOs.

Attributes preferably associated with DDO as used herein are the DDO's name, its content, data flags useful for defining DDO state, a parent list (which is a local registry of parent DDOs and could contain references to multiple copies of any parent), a child list (which is a local registry of children and could contain references to multiple copies of any child) and inherent methods, which are methods that allow the DDO to implement some of the basic functionality of an DDO. These characteristics are by no means limiting.

Embodiments of the present invention can be viewed as application programming systems rather than data storage and retrieval systems, although such embodiments also have excellent data storage and retrieval characteristics. In the application programming sense, each DDO can contain code to perform some function. If an DDO requires the code of another DDO, it requests that the needed DDO be retrieved and executed, possibly over a communications network in a distributed system.

One of the objects of the current application is to provide a data and code storage and retrieval structure that has performance independent of number of data elements, is robust, has no single point of vulnerability, allows dynamic updating of DDOs and their structures, and enables the distributed execution of DDO methods within the structure.

In order to efficiently manage the storage and retrieval of dynamic, distributed objects, such objects are preferably attached to the branches and leaves of index trees. Further, indexes are maintained to enable fast presentation of all objects contained in any branch of the tree. This results in search complexity being time-constant, or at worst sub-linear. The tree generated converts the usual nlogn time complexity for data retrieval to sub-linear time complexity for data retrieval that would be the case if the objects were listed under a single dynamic distributed object.

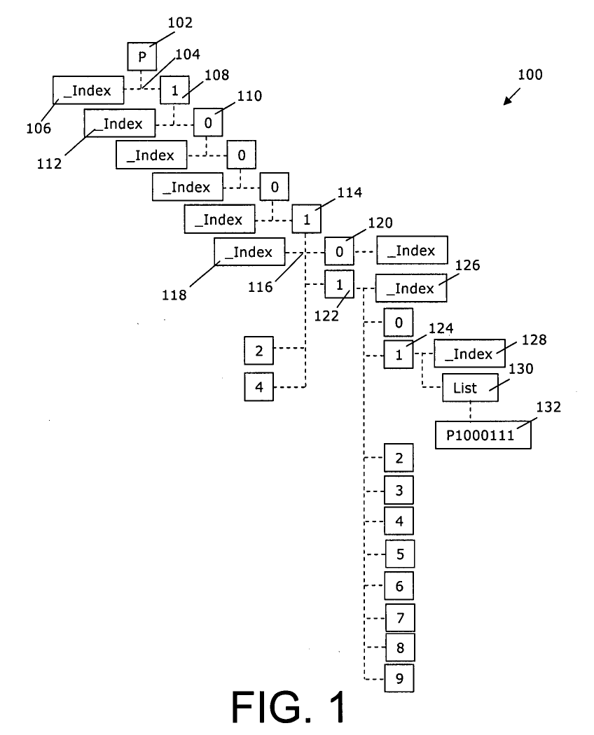

Referring now to FIG. 1, a preferred index tree implementation 100 is shown. Tree 100 has a number of dynamic distributed objects as shown by content in boxes, such as objects 102, 106, 108 and 112. Reference numbers have not been assigned to each DDO in order to simplify the drawing and the explanation.

In the tree 100, each DDO has attachment relationships to other DDOs as shown by the dashed lines (for example, attachment 104) between boxes. The attachment relationship means preferably that each DDO carries with it one or more location records indicating the storage location of an attached object. Of course, two objects can be attached transitively through another object, in which case the present disclosure will use the term “ultimately attached” to mean that the attachment can be, but must not necessarily be, over one or more intermediate objects. The storage location is preferably a direct pointer to the physical or logical address of the object's non-volatile storage location, but can be any type of location reference, including a reference to a local cache copy of a non-volatile stored copy. Preferably, the attachment relationship is bidirectional—that is, when two objects are attached, each object has a storage location of the other object.

Tree 100 has a top DDO 102, which can be viewed as a root object but which is more likely to be attached to another part of a tree (not shown). DDO 102 is a data storage object having content “P.” DDO 102 further has attachment relationships to two child DDOs 106 and 108. DDO 106 is an index DDO, which is present in a preferred embodiment and preferably comprises information about all DDOs attached below DDO 102. DDO 108 is a further data storage DDO having content “1.”

Tree 100 continues from DDO 102 with DDO 108, which has a child DDO 110 comprising data “0,” as well as a child index DDO 112, which comprises information about all DDOs attached below DDO 108. The tree 100 continues in similar fashion until DDO 114.

DDO 114 has an attachment relationship 116 to an index DDO 118 and a number of other child DDOs, for example, DDO 120. This indicates that there are a number of possible choices or variants underneath DDO 114.

A search through tree 100 is facilitated by the structure of tree 100. In FIG. 1, the application might be searching for a record with the search key “P1000111,” for example. A “search key,” as used herein, is a piece of information that can be used to identify a data record, such as a last name associated with a file. In using the search key, the application retrieves DDO 102, which contains the content “P.” Since “P” matches the first character element of the search key, the application searches for child DDOs matching the character “1” and follows successive child DDOs until the desired search key is found or conclusively not present.

DDOs 122 and 124 are shown expanded in FIG. 1. That is, the full content for these DDOs is shown, whereas other DDOs may have additional child DDOs that are not shown. In particular the DDOs at the same level as DDO 124 have similar child content. DDO 124 has index DDO 128, container DDO 130 and content DDO 132. The container DDO 130 is an optional wrapper for the ultimate content of the tree 100. DDO 132 is typically, but not necessarily, a “leaf” or end-node of tree 100.

Certain embodiments can facilitate the provision of quick-search lists or index DDOs that are attached to each node of the tree. In this embodiment, as the tree is traversed in order to insert a dynamic distributed object, it each node T_{L} traversed, the index data element of the object is added to the list of index data elements already stored at that node. In this way list at each node in tree contains a list of all data elements of the index of the dynamic distributed objects attached in the tree below the node.

Thus, index DDOs comprise preferably a list of objects attached at the level of the respective index. As an example the content of index DDO 126 preferably comprises the following list, which includes all members at that level of the tree:
P1000110
P1000111
P1000112
P1000113
P1000114
P1000115
P1000116
P1000117
P1000118
P1000119

In general terms, the storage and retrieval embodiments can be described as follows. Let D={dᵢ, i=1,2, . . . n} be a finite set of dynamic distributed objects dᵢ each with data elements d_{i,j} where j=1, . . . , nᵢ. Let d_{i,k} (i=1,2, . . . n) be data elements to be used to access the dynamic distributed objects. Now let the data contained in the data elements, d_{i,j}, be represented by the ordered n-tuple (d_{i,j,1}, d_{i,j,2}, . . . , d_{i,j,k}) which forms a partition of the data element d_{i,j}. As used herein, the term “partition” means a collection of discrete subelements which, if put back together, would result in the partitioned object. A “discrete subelement” is some identifiable portion of the partitioned object that can be matched in search routine, such as an individual letter, number, or sequence of letters and numbers.

Embodiments of the invention relate to the structuring of the dynamic distributed objects into a tree of dynamic distributed objects where for each d_{i,j,r} of the partitioned data element there is an associated dynamic distributed object on the r^{th} level of the tree. The final leaf of the tree, representing the last partitioned data sub-element d_{i,j,k} then has the full dynamic distributed object attached to it, either directly or in a further dynamic distributed object used as a container for objects with data element d_{i,j} of the same value as d_{i,j}.

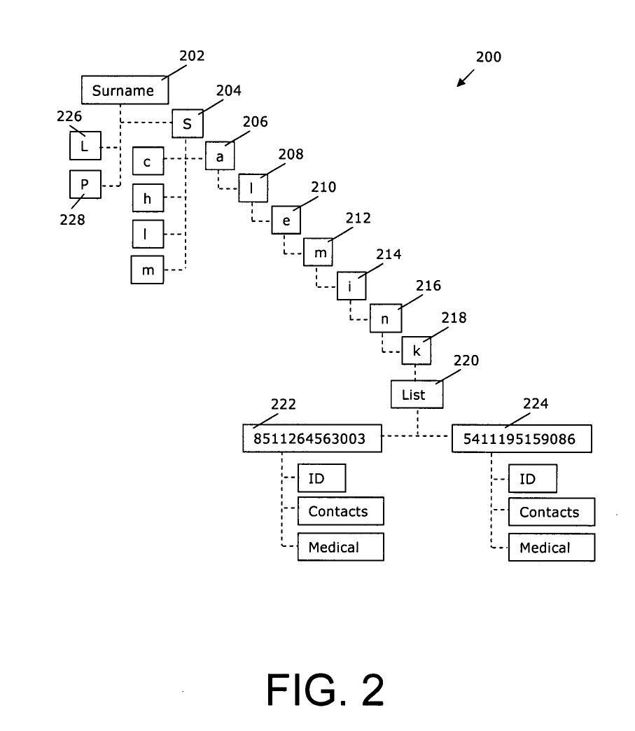

The situation is illustrated in FIG. 2. FIG. 2 shows a tree 200 having a top node 202 with the content “Surname.” FIG. 2 further illustrates an example for looking up medical records based on the surname. In tree 200, d_{i,j} can be seen as “SALEMINK” and the partition is {“S,” “A,” “L,” “E,” “M,” “I,” “N,” “K”} as shown by DDOs 204-218. These DDOs are attached in parent-child relationships and effectively form a chain of subelements which can be followed to reach the sought after data. As can be seen under DDO 218, which is d_{i,j,8} (the node “K”), or the last subelement in the search key, there is another DDO node 200, representing the container “List” that holds two DDOs 222 and 224 representing medical record information, each of which has “SALEMINK” as the search data element.

The “Surname” DDO 202 has child DDOs 204, 226 and 228, representing the letters “S,” “L” and “P” respectively. In the tree 200 as shown in FIG. 2, this means that the system has records for people whose surnames begin with those three letters. Again, while DDO 204 is shown in expanded form to illustrate its contents, DDOs 226 and 228 are not and will have additional child DDOs.

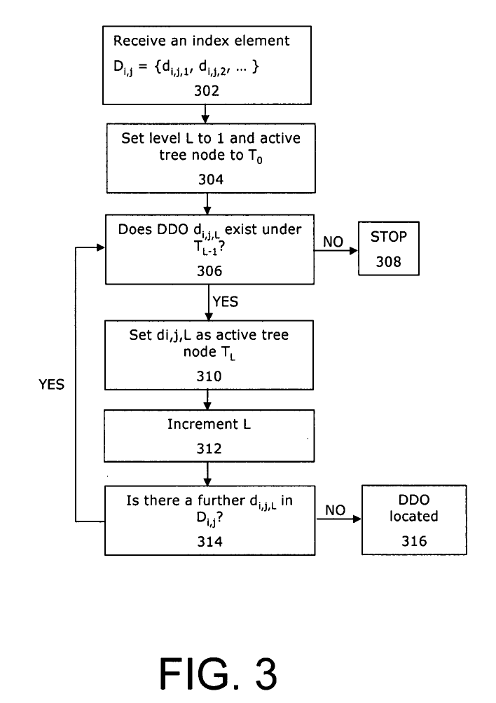

The tree structure as illustrated in FIGS. 1 and 2 allows for the efficient retrieval of the dynamic distributed objects. Such retrieval is implemented as illustrated in FIG. 3. At step 302, a search key element D_{i,j},={d_{i,j,1}, d_{i,j,2}, . . . , d_{i,j,k}} is received, for example as the result of a search query, where the data in curly braces is the partition of the search key element D_{i,j}. At step 304, the current active tree node is set to T₀ and the search level L is set to L=1.

At step 306, the system checks whether a dynamic distributed object with name d_{i,j,1} exists under T₀. If no such dynamic distributed object exists, the search result is empty and the system stops the search at step 308. If the object d_{i,j,1} exists, the system sets d_{i,j,1} as the active tree node T_{L} at step 310, and increments the search level L at step 312. The system then checks, at step 314, whether a further DDO partition element exists in the search key D_{i,j} at step 314. If not, the search is concluded at step 316, since the corresponding DDO has been located. If further partition elements exist, the system loops to step 306.

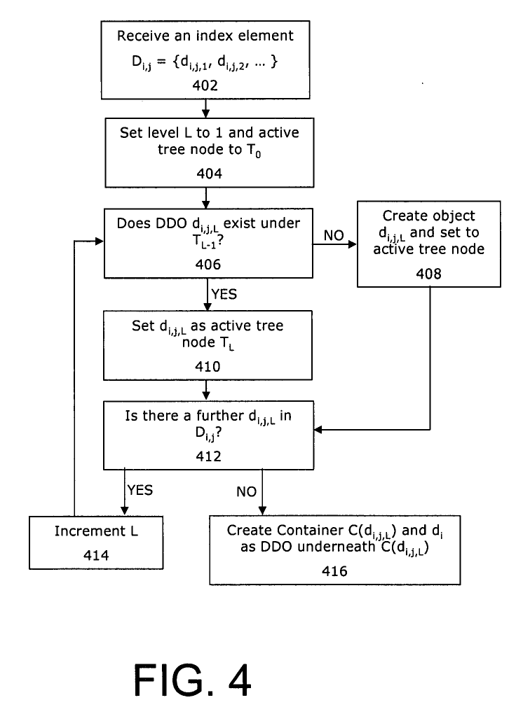

FIG. 4 illustrates the situation where a DDO is created and dynamically inserted into an index tree structure with root node T₀. At step 402, a search key element D_{i,j},={d_{i,j,1}, d_{i,j,2}, . . . , d_{i,j,k}} is received, for example as the result of a search query, where the data in curly braces is the partition of the search key element D_{i,j}. At step 404, the search level is set to L=1 and the active tree node to T₀.

At step 406 the system determines if a DDO with name d_{i,j,1} exists under T₀. If not, the system creates such an object and refer to the object as the active tree node T_{L} at step 408. If d_{j,j,1} is found under T₀, it is set to the active tree node T_{L} at step 410.

The system then checks, at step 412, whether a further DDO partition element exists in the search key D_{i,j}. If not, the search is concluded at step 416, since the correct position corresponding DDO has been located. The DDO is either then inserted directly, or a container DDO is created to contain the DDO as an attached child DDO. If further partition elements do exist, the system increments the search level L at step 414 and loops to step 406.

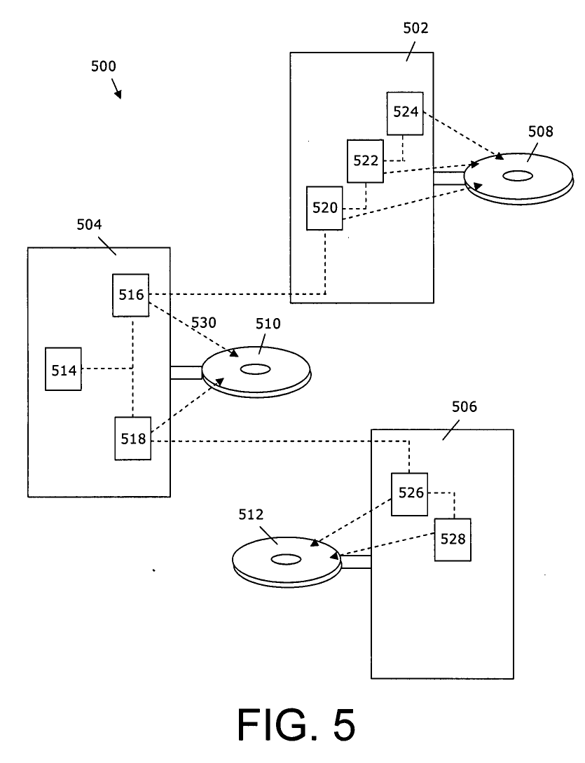

FIG. 5 illustrates a distributed application system 500. System 500 has a number of processor units 502, 504 and 506, which are in communication with one another, preferably over a network such as the Internet (not shown). The processor units can be viewed as nodes on such a network, and will generally comprise one or more hardware and software servers, the hardware of which will include one or more microprocessors and memory space. The memory space, including non-volatile memory described below, may have code embedded therein for being executed at the processing unit and carrying out the various methods described herein.

Processor units 502, 504 and 506 have access to non-volatile storage media 508, 510 and 512 respectively, which can be as shown here hard disk storage, but can also be, for example, optical disk storage, Flash ROM, EEPROM, etc.

The system 500 operates with a tree structure of DDOs 514-528, which can be, but are not necessarily, distributed across several systems. The tree structure is shown by the DDOs 514-528 therein and dashed lines showing, as in FIGS. 1 and 2, attachment relationships between DDOs. As shown in this preferred embodiment, each DDO, which may be cached in volatile memory space of a respective processor, optionally maintains a link to the physical or logical location of its serialized form in non-volatile memory, as indicated by the dashed lines with arrowheads, such as pointer 530.

The DDOs of the system 500 may contain data and/or code, and in this embodiment work together to form an application system. The tree structure in system 500 has a top DDO node 514 with two direct child DDOs operating on the same processor unit 504. DDO 516 has child DDO 510 on processor 502, which in turn has child DDO 522 which in turn has child DDO 524, which is a “leaf” on the tree structure. DDO 518 has child DDO 526 on processor unit 506, which in turn has child and “leaf” DDO 528.

DDOs 524 and 528 can form desired content DDOs at the bottom of an index tree as described herein. That means that DDOs 514-522 and 526 can form partitions of search keys as described in reference to FIGS. 1-4. Since each DDO may be attached to multiple child and parent DDOs, it is also possible that DDOs 514-528 are content and/or code DDOs which work together to form an application system. An index tree according to the present embodiments can thus be attached in parallel to the application programming system without disturbing its function.

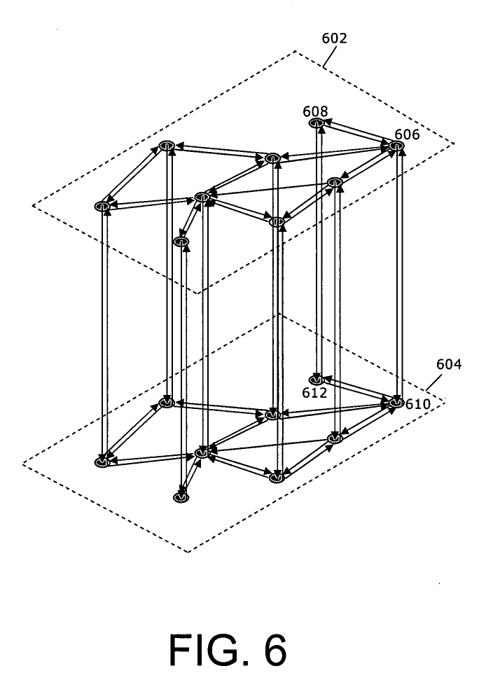

Further embodiments of the invention relate to the organization of DDOs in an application, not just to methods for indexing them. Preferably, DDOs using parent and child relationships for a hierarchical tree structure with a root node. In order to manage DDOs in a dynamic fashion, DDOs are preferably constructed by integrating two layers of DDOs, a “nodal” layer and an “information” layer. This structure is shown in FIG. 6, where each arrow represents a pointer, stored at the DDO at end of the arrow, that points to the DDO at the head of the arrow.

The system 600 has a nodal layer 602, which is a pointer management layer. This layer contains nodes, represented in the Figure by enclosed circles, for example, nodes 606 and 608. Each node in layer 602 points to a respective node in information layer 604 (and vice versa) that holds information concerning the DDO and is, in a preferred embodiment, stored in non-volatile storage. For example, node 606 points to node 610 in the information layer. In addition, nodes in nodal layers 602 and 604 have parent and child relationships as indicated by the pointer arrows. For example, node 606 has node 608 as a child, while node 608 has node 606 as a parent. Correspondingly, node 610 has node 612 as a child, while node 612 has node 610 as a parent. Each node may have its persistent storage associated with a different computing system on a network.

Using two layers, the distributed nature of the actual information DDOs can be managed. The address of an DDO is recorded as a register list of one or more of its possible physical locations on a disc drive (or within a particular file on a particular disc) on a particular machine. Of course, other forms of non-volatile storage are possible.

As stated above, the parent and child register lists point to the nodal DDO that references the information DDO which together form the referenced DDO. In this way the DDO is fully dynamic and the nodal layer acts as an interface layer for the information layer. However, as the information DDO also has the full list of its parents (DDOs which refer to it) the structure of a DDO is fully symmetric and the role of information DDO and nodal DDOs are interchangeable and the nomenclature purely depends on the relative point of access on the DDO.

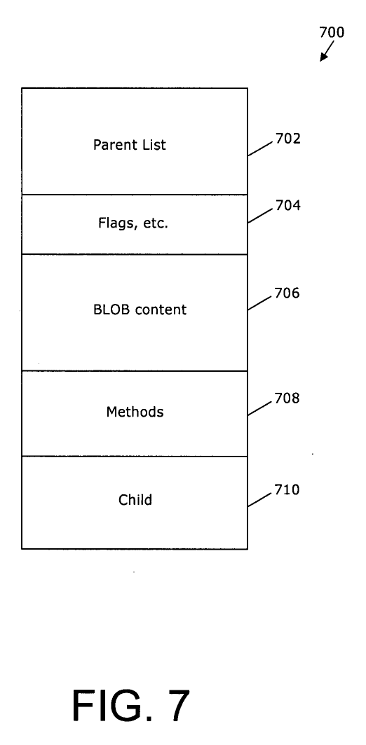

FIG. 7 shows a typical serialized DDO structure 700 in the information layer. The DDO has a parent register 702 with pointers to parent DDOs, a section of data 704 for flags and other status data, a Binary Large Object section 706, which is a definable data or code payload, an inherent methods section 708, and a child register 710, with pointers to child DDOs.

The proposed information structure is unique, among other reasons, because the retrieval of information can be structured to be independent of the number of data elements directly addressed. The information structure proposed is that of a distributed, dynamic, event driven, intelligent information DDO with persistence architecture. The architecture is designed to enable the development of applications which are independent of the number of DDOs on which the application relies.

This is achieved by implementing direct associative structures between information DDOs, as described with reference to FIG. 6. These direct associative structures are dynamically altered as the state of the information DDOs change. These dynamic associations are then used to navigate through the information. Further, the association is identified by a parameter indicating the “strength” of the association and this too is configurable and adaptable not only at time of creation of the association, but also every time either DDO involved in the association is accessed. The association strength can further be eroded from lack of use. In effect, the information structure attempts to emulate the manner of recall of human memory.

Further, the fact that all associations are direct addressing of the data DDO referenced, there is no architectural limit to the size of the information structure. The information structure is only limited by the number and size of physical storage spaces made available to the information structure (e.g., servers made available over the Web).

The information structure will provide a repository with the required flexibility and scalability for very large data collections. The information structure will further enable a fully distributed repository with built-in multiple redundant storage resulting in a robust storage structure with no single point of vulnerability.

The information structure proposed is dynamic, intelligent and fully distributed. By its nature the system implements full grid computing that results in a powerful “network computer” where the whole network acts as a computing unit.

For example, in the case of a business information management system for a shoe store, the information structure would reflect the reality of the business situation in the shoe store. Each shoe in the store would have a counterpart shoe DDO in the application. Each teller would have a counterpart DDO in the application, each DDO teller would have methods that correspond to the roles that the real teller performs. If a customer brings shoes to the teller, the teller would ring up the shoes and this would trigger for example, a “ringupshoes” method of the teller object. This method would then initiate all the actions that this event would typically trigger relating to the the pair of shoes bought, “Shoe3245,” would be removed from the container DDO “ShoesOnRack,” the shoes would be moved from the DDO, “ShoesInStock.”

The removal of the shoes from the “ShoesInStock” DDO would further trigger the “StockValue” DDO to be re-evaluated. The change in the “StockValue” DDO would, in turn, cause the “Current Assets” value in the “BalanceSheet” DDO to be adjusted, and so forth Also the “Shoe3245” may be attached to the “ItemsBought” node of the “Customer232222” DDO, etc. In this way the impact of the event of the purchase of a pair of shoes is “rippled” through the system. The sale would further enable the impact of the sale to ripple through all relevant structures immediately and any required comparisons of expense line item ratios could be performed. Any anomalies could them be logged and the relevant DDOs notified. These DDOs could, in turn, be either internal notification, which could fire further evaluation and testing, or external notification to a person or other external system.

This event-driven manner of application design results in a “Just-In-Time” equivalent solution for information structures. An event's impact therefore triggers the updating of all affected elements of the system, including all reports, which, when viewed would always be current. The reports would not have to be run at month-end or day-end, the reports would be current at the end of each day or month. Results and reports are not run at specific times but are continually kept up to date in the system.

The information structure proposed further allows the “grain” of the information to vary within the storage structure and still further allows the “grain” of the information to vary between “Viewers.” By this is meant, for example, that if one were looking at the current stock of shoes in the shop described above, a shop assistant searching for a red shoe of size 4 and style “Gothic Chunky” would be able to see each of the shoes ordered by size and style. The manager would see a view of the aggregate number of shoes by size and type.

One aspect of certain embodiments described herein is that of the DSA (Distributed Stack Architecture). Essentially, the interaction manager (or “service”) application execution stack is abstracted and componentized. The interaction manager or “service” on each platform provides several application services to DDOs, including the services of, for example, persistence (storing DDOs to non-volatile storage), communication (use of hardware network resources), user interaction (access to peripherals such as monitors and keyboards). Code for these application services are loosely coupled through interfaces in the execution stack. This allows the components to be swapped in an out during execution. For example, if a new type of hardware communications device is installed, the communication service can be altered by changing the interface to point at new service code particular to the new hardware.

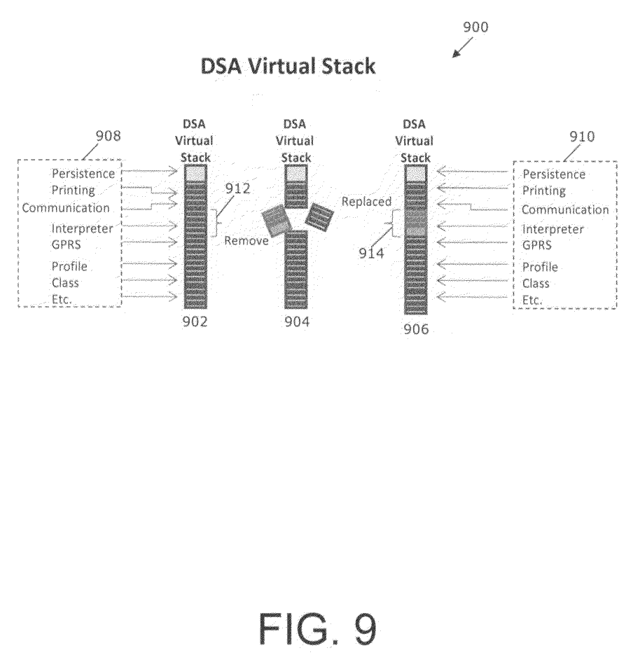

This is illustrated in FIG. 9. FIG. 9 shows a service application 900 with a virtual stack 902, providing application services 908 to DDOs. FIG. 9 shows three steps of replacing a portion of the virtual stack. A portion 912 of the service stack 902 is removed in an intermediate step 904, and replaced with a new portion 916 in the virtual stack at 906. The new portion can represent, for example, a new service specific to a particular platform.

The DSA structure additionally preferably provides for the use of profiles. The profile of a DDO is a DDO entry layer that enables the manner of presentation of a DDO to vary depending on the identity of the user. The purpose of implementation of profiles for an object is multifold. In one instance profiles can be used to implement security and access to DDOs. As the profile layer is preferably the first layer that is executed when accessing a DDO, it is the best place to implement DDO security. The profile layer can also be used to implement different languages in the system by having the profile translate the names of attributes and methods within any accessed DDO.

Another purpose of the DSA is to provide a ‘Context’ for each DDO to operate within. This context rather than the DDO itself defines the behavior and it is the reaction of each DDO to different contexts that define various behaviors. With DSA, the context of a DDO is determined by its access path.

As an example, a group of people all have essentially the same DNA and thus basic behaviors and properties i.e. heart beat, body temperature, metabolic rate etc. But all these change in terms of environmental factors i.e. stimulus range, temperature, resource availability etc. So at a certain point of time all these persons may behave in completely different ways although they are, physically essentially the same.

In the realm of standard objects in any object-oriented programming language, the inherent behavior and associations that an object possesses, the “context,” is defined by the hierarchical class structure to which the object belongs. In the realm of DDOs there is no class structure (or a very limited class structure) and the inherent behavior and associations have to be provided in another manner. DSA allows the context of the DDOs which it presents to be defined within the architecture of the interaction manager. This context definition then defines the relational structure of the DDO within the cyber environment of the object.

In the case of the DDO implementation of DSA, the context is defined as the access path used to retrieve the DDO. If one accessed the shoe “Shoe3245” of the example above from the DDO “SoldShoes” and then queried “Shoe3245.parent( )” the return would be “SoldShoes.” However if one accessed the same “Shoe3245” from the DDO “Customer232222” and then queried “Shoe3245.parent( )” the return would be Customer 232222.” The fact that the contexts of the identical objects differ allows for the behavior of identical DDOs to be dependent on their context. This property effectively enables within the DSA framework the advantages of inheritance of the usual object-oriented technology, without many of the disadvantages of that technology.

One specific instance of the present invention is the World Wide DDOs 5 server and associated Service Stack.

The World Wide DDOs (WWO) is an associative DDO oriented storage and management system with transactional and multi-user capabilities. It scales to a wide range of platforms including Linux, Mac Os X and Win 32. It has a platform independent code base for easy migration to other platforms. It also provides a DDO Relational Model and Service Stack for binding different language, storage, security and transactional services.

Transactions: The WWO DDO Provides Multiuser ACID compliant transaction architecture for creating and updating new DDOs. Transactions are session based and isolated at OS level. They may be very long running i.e. hours before committing. DDOs can be created at up to 30000 associates per second regardless of attribute count on a 2 GH desktop with 1 Gb Memory and 7200 rpm SATA drives.

Data Size: Each DDO in this implementation consumes between 50 and 150 bytes depending whether an attribute or structural item is used. Unused attributes are not stored and only the amount of content actually defined is stored. Any attribute can be indexed according to DDO and indexes have no limit in attribute size. An index adds 50 bytes per DDO that actually has the indexed attribute set.

Multiple Storage Paradigm: DDO attributes can be stored as physical attributes like traditional RDMS's, Other Associates or user defined XML data types.

Multiple Interpreters: The communications stack is driven by a proprietary IDL that allows the binding of multiple languages to any layer in the service stack. Currently this allows the server side usage of XML and Lua. This allows automatic proxying of client code so that user functions can be called directly from within the process that accesses the storage hardware. Bindings for other languages e.g. Python are also envisaged. Attributes and structures are immediately available as syntactic sugar to developers saving hours of Manual ORM definition and building. Binding resources are automatically garbage collected and recycled for resource efficiency and ease of development.

JIT Compiler: Storage Procedure Code is JIT (Just In Time) compiled and optimized for optimal execution speed. This allows for e.g. scientific numerical calculations or other computationally demanding tasks to be executed at near compiled speeds.

Data Distance: Because DDOs can be associated or contextualized to any number of other DDOs, data can be contextualized in terms of whatever criteria or DDOs are required on creation. This reduces query time and retrieval logic associated with Relational Database Management Systems. DDOs may also be stored in smart contexts which only produce DDOs related to the current context.

Service Stack: Each DDO is interpreted in terms of the current Service Stack i.e. Client, Server or Remote so that DDOs can be easily virtualized to the most efficient storage context. Procedures can be tested on client side before committing to server for ease of development.

Advanced Cache Technology: DDOs are cached using advanced compression technology allowing for near constant retrieval times, medium datasets of over 25 000 000 DDOs can be cached in 1 Gigabyte of System Memory. This also allows near memory speed access of persisted DDOs. It also allows for scaling to high concurrency environments because the physical storage is rarely accessed and concurrent locking of slow disk-based data is vastly reduced. It is an excellent XML storage paradigm for quick retrieving and parsing of large XML documents.

ACCESS Speed: The Advanced Caching Technology together with optimized tree and leaf data structures ensures that near constant retrieval times are achieved. Random DDOs can be accessed at the rate of approximately 100 000 DDOs per second regardless of attribute count on a 2 GH desktop with 1 GB Memory and 7200 rpm SATA drives.

Platform Independent IO: All IO can be used and moved from any supported platform to any other supported platform regardless of bit-ness or byte order which allows easy migration to new hardware architectures. This includes file systems, transactions and communications.

Built-In XML support: An Event Driven Sax XML parser is included, allowing fast indexing XML documents of multi Gigabyte size.

XML GUI Resource Support: GUI resources may also be defined using XML resource definitions. A model driven GUI definition tool is available to generate WWO DDO models that can translate to HTML ,Win32 and Gnome environments. Any other generator i.e. XHTML etc. can be added to this suite for portal and multi platform generation.

A number of the interfaces used with specific embodiments of the present invention will now be described.

Intra Context Interface: This interface is loosely coupled and is only discovered at runtime to ensure enough flexibility to facilitate (allow) DDO profile creation. The context comprises various system-defined elements arranged in the form of a stack. This stack is stored using a persistent storage mechanism. Each element has a set of operations to provide application services and attributes for the context within which a DDO operates.

All methods defined by a class have access to this context. The context of an DDO is available exclusively to that DDO to prevent interference by other DDOs. The only access to an DDO context is by DDO-defined interfaces.

Interface Definition Services: These services are required by a Root context when a new Context element is registered or the context services are booting up. It allows a stack entry element to publish services that it can render within any given context.

Method definition: The root context is sent a string (by a new Context element type) containing various sequences that can define the attributes and methods available from a stack element i.e. suppose one requires an interface that has two methods and one attribute one method will be ‘lock’ the other ‘unlock’ and attribute of the name ‘hasLock’ of type integer. A method definition string is formatted as such:

<interface name=“locker”>

<method name=“lock” type=“void”>

<parameter name=“” type=“void”/>

</method>
<method name=“unlock” type=“void”>

<parameter name=“” type=“void”>

</method>
<attribute name=“hasLock” type=“integer”/>

</interface>

A more complex interface with methods and parameters types:

<interface name=“ProfileDefinition”>

<method name=“addAttribute” type=“void”>

<parameter name=“name” type=“string”/>
<parameter name=“type” type=“string”/>

</method>
<method name=“create” type=“void”/>

</interface>

A short hand format is also available and this translates to

“ProfileDefinition.addAttribute(name:string,type:string) :void”
or defined as [<static>] [ ]<Interface name>.<method
Name> ([ ]{<parameter name>:<parameter type>|<[ ]>[ ] [n-1{,}]}[ ]);

where [ ] indicates any amount of white space and everything within {} can be repeated n times and [n−1{,}] indicates that it (all within {}) is only repeated the first n−1 times.

Method Invocation: To invoke a method on a element service the following call is passed to the interface:

<call interface=[ProfileDefinition]>

<method name=“addAttribute”>

<paramater name=“name” value=“FirstName”/>
<paramater name=“type” value=“string”/>

</method>
<method name=“addAttribute”>

<parameter name=“name” value=“Address”/>
<paramater name=“type” value=“string”/>

</method>

</call>

In the short format it will be

### ProfileDefinition.addAttribute(name:“FirstName,”type:“string”)

Parameter Encoding during and for method invocation: String Parameters values used during invocation are always wrapped using quotes to define value boundaries if a value contains a quote it must be preceded by a back slash character. To include a back slash it must be preceded by a backslash.

Blob values should be encoded and sent as is with the first character a ‘B’ and then the rest of the data. There are no limits to the amount of data to be sent. Termination of the blob sequence is automatically any character that is not included in the base 64 encoding set.

Base 64 encoding set:

Character

ABCDEFGHIJKLMNOPQRSTUVWXYZabcdefghiklmnopqrstuvwxyzs01234

56789#@

| | | | | | |
|---|---|---|---|---|---|
| Radix | 0 | 1 | 2 | 3 | 4 |

| | |
|---|---|
| 5 | 6 |

012345678901234567890123456789012345678901234567890123456

7890123

This set must be used to encode blobs for transmission in this embodiment. The underlying streaming protocol may choose to encode these values in a more compact format as long as the output remains the same as the input.

Integers and floating point values should be specified in their native utf-8 format i.e. Subject.setAge(55)

Arrays: Arrays of results are specified using the [ ] operator after the type name:

i.e. to define

City.setRoads(names:string[ ])

to invoke

City.setRoads([“park avenue,”“rosswell lane”]);

Static Context Interfaces: Static interfaces are also available to DDOs and publishes sub contexts available to all Super contexts.

Context itself publishes the following methods, which are not static interfaces. The context interface is also the only built-in interface available immediately to any requesting clients. All other interfaces are accessed through the contextualize function.

### Context.instantiate(string:name):void

Instantiates the context of a specific name, path or id of an DDO. This instantiation is part of the normal DSA client interaction.

Context.instantiate( ):void instantiates the system or
anonymous context
Context.addMethod(methodDefinition:string):void
Context.getInterfaceNames( ):string[ ]

Return all the configured and registered interfaces for this context.

### Context.getMethods( ):string[ ]

Return a list of method definitions that can be invoked. In the case of the context interface itself this will return

[“instantiate(string:name),””instantiate( ):void,””addMethod(me
thodDefinition:string):void,””getInterfaceNames( ):string[ ],””g
etMethods( ):string[ ],”...]
Context.getMethodNames( ):string[ ]

Return a list of unique method names that can be invoked on the current interface. In the case of the context interface itself this will return

[“instantiate,””addMethod,””getInterfaceNames,””getMethods,”...]
Context.getMethodParameterNames(name:string,parameterTypes:str
ing[ ]):string[ ]

Return the parameter names of a <Interface>.<Method> definition. The interface may only be one of the directly known sub or super interfaces. These may also include static interfaces.

Context.getMethodParameterTypes(completeDefinition:string):str
ing[ ]

Return the parameter types of a <Interface>.<Method> definition. The interface may only be one of the directly known sub or super interfaces. These may also include static interfaces.

### Context.invoke(invocation:string)

Invoke an interface registered with the context as specified in one of the formats above.

### Context.contextualize(interface:string):void

Contextualize to given interface name. The results of getInterface* and getMethod* methods will differ after contextualize(i) is called to that of the current interface. The ‘invocation’ parameter may only contain names directly known to the current interface. In real terms this is either the parent of this interface or any of its directly known sub interfaces.

These methods may be overridden by the current interface to provide more interfaces in a hierarchy of interfaces.

### Context.override(method:string)

Specifies that the method defined by the method argument may be reimplemented by the current interface. This method is experimental.

System Definition: This section defines concrete interfaces that allow the system to interact with other systems and components available to the host.

ProfileDefinition: defines attributes required by this profile

Profile: defines profile iteration and discovery and transactional functions on the underlying DDO storage.

Credential: Maintains User or system credentials.

Associations: Maintains relationships and associations to other DDOs.

Data: Contains raw data.

Behavior: DDO specific behavior and user defined contextual interfaces.

Attributes: Defines localized named DDO attributes. A specific profile may be searched by attributes to find DDOs with required attributes.

Invocation and discovery mechanism: The DSA service publishes a configuration file on the service host environment. This property file contains information about available stack elements. These can be defined in dynamic loading libraries. In Win32 environments these would be .dll in linux and other unix like environments these would be so files or shared DDOs in the operating system. The configuration format is as follows:

module.name=<name>
module.<name>.library=url

Each library registered must in turn include these C interfaces:

struct Argument {

int type; // the type
char * name;// points to a name in the caller address

space

void * value;// points to data in the

};
// type is an enumeration of the following values
// 0 integer
// 2 real
// 4 string
// 8 blob
// a total of 32 primitive types are allowed, but the other
flags
// will remain largely unused
//////////////////////////////////////////////////////////////
///
typedef invocation(char*,Argument*,int);
char* register( );// must return the interface format as
specified in the Intra Context Interface definition
Argument* invoke ( Context* context,//context on which

char * method,// method to invoke
Argument[ ] arguments,//values of

argument structures

int count // argument count
); //invoke method within the current

interface
// A dynamic loading error will result if functions with these
//specifications does not exist

Storage module: The storage module is responsible for creating and managing profiles. A profile contains all the information to describe a ‘class’ of DDOs these can be ‘attributes’ and ‘relationships’. Unlike traditional relational databases any DDO or class can be related to any other DDO or class at any time. Also various ‘types’ of associations can be defined and handled in a author defined ways.

Given the requirements of the DSA as stated in the Intra Context Interface definition, it is one of the goals of the DSA storage module to partake within a certain context and produce methods and properties for other members of a certain context to interact with it. A profile also contains the definition of the Context stack entries. These members are: ProfileDefinition: a static context member that determines the internal properties of a class i.e. First Name, Surname, Address etc. The profile DDO is used within the context of the administration tool to define new profiles. It is always available to all DDO contexts except where security restrictions apply.

Create a Profile with attributes—throws an exception if no attributes are available.

static ProfileDefinition.create(name:string):void

The type field can be “integer,”“real,”“string” and “blob.” An integer is interpreted as a 64-bit signed integer. A real is interpreted as a 64-bit floating point value. A string is a utf-8 formated string. A blob can be any binary value as large as volatile memory allows.

static ProfileDefinition.addAttribute(profile:string,
name:string,type:string):void

Similarly an attribute can be removed:

static ProfileDefinition.removeAttribute(profile:string,
name:string)

An attribute or set of attributes can be indexed for faster retrieval. By

static ProfileDefinition.addIndex(profile:string,
indexName:string, names:string[ ]);

or removal by

static ProfileDefinition.removeIndex(profile:string,
indexName:string)

There is a linear degradation on DDO creation performance for each new index added by the ProfileDefinition interface. In other words the first index will cut creation performance by a third the next index performance would be cut by a quarter the next index would have performance cut by 12.5% etc. DDO retrieval especially searching using the Profile interface will increase by as much as 1000% or more. It is wise to have only one index containing all search able user fields for maximal performance. In the particular instance of the implementation of DDOs within DSA, no indices are added.

The DDO profile interfaces: The Profile interface is used to navigate and search through DDOs of a given profile. To access the static profile interface the following command string is used:

### Context.instantiate(“Profile”);

To access the dynamic profile interface Context.contextualize is used as in the following example:

### Profile.contextualize(“YourProfileName”);

This will move the cursor to the first available DDO for that profile. To move to the next DDO in the current profile Profile.next( ):void is used. To search for an DDO containing a specific attribute, use:

Profile.find(attribute:string[ ], matchValue:string[ ],
operators:string[ ]);

Match value is interpreted using the rules specified in the intra context interface section. The attribute argument is used to specify which attribute should be searched on.

Although the foregoing is described in reference to specific embodiments, it is not intended to be limiting or disclaim subject matter. Rather, the invention as described herein is defined by the following claims.

What is claimed is:

1. A method for storing data for retrieval, comprising the steps of:
determining a search key for the data;
partitioning the search key into discrete subelements;
creating an object for each subelement;
attaching the respective object for each subelement to its nearest neighbor in the search key to form a chain of attached objects;
and attaching an object containing the data to the last subelement of the search key.

2. The method of claim 1, further comprising:
attaching at least one index object as a child to an object comprising a discrete subelement.

3. The method of claim 2, further comprising:
attaching at least one index object as a child to each object comprising a discrete subelement.

4. The method of claim 3, wherein each index object has a direct parent object, and wherein each index object comprises a list having one or more entries, each entry representing an object that is attached as a child object to the direct parent object.

5. A system, comprising:
at least one processor unit including a processor for executing code and a memory space;
the processor unit having access to a plurality of objects;
wherein the plurality of objects forms a chain of objects attached to one another and comprising a search key, and wherein one object in the chain comprises a data element identifiable by the search key.

6. The system of claim 5, wherein the system comprises a plurality of processor units and the objects are distributed among the processor units.

7. The system of claim 6, wherein each processor unit comprises non-volatile storage; and wherein each object comprises a reference to its own storage location in the non-volatile storage.

8. A method for retrieving data, comprising the steps of:
receiving a search key for the data;
partitioning the search key into discrete subelements;
following a chain of child objects matching the discrete subelements in order; and
retrieving the data in an object ultimately attached to an object comprising the last discrete element of the search key.

9. The method of claim 8, further comprising:
using at least one index object attached as a child to an object comprising a discrete subelement.

10. A method for the organization of at least part of an application, comprising:
providing a plurality of dynamic distributed objects that comprise executable code;
providing, for each of the plurality dynamic distributed objects, a parent object register and a child object register within each object; and
providing a nodal layer and an information layer for storing the plurality of dynamic distributed objects.

11. The method of claim 10, wherein for the plurality of dynamic distributed objects, the nodal layer and the information layers have symmetrical nodal structures.

12. The method of claim 10, wherein the step of providing a plurality of dynamic distributed objects that comprise executable code further comprises providing dynamic distributed objects that comprise flags and inherent methods.

13. A system, comprising:
at least one processor unit including a processor for executing code and a memory space;
the processor unit having access to a plurality of dynamic distributed objects;
wherein the plurality of dynamic distributed objects forms two nodal layers that are symmetric in their nodal structure.

14. The system of claim 13, wherein:
each of the plurality of dynamic distributed objects comprises a parent register and a child register.

15. The system of claim 13, wherein:
each of the plurality of dynamic distributed objects comprises flags and inherent methods.

16. A method for managing an application stack comprising:
providing a plurality of application services in a stack;
providing access to each application service through an interface; and
replacing the code for an application service during execution of the application stack.

17. The method of claim 16, wherein the application stack is a service to a second application formed of a plurality of dynamic distributed objects.

18. A system, comprising:
at least one processor unit including a processor for executing code and a memory space;
the processor unit having access to a plurality of dynamic distributed objects;
wherein the processor unit executes a service that comprises code for at least two application services; and
wherein the at least two application services are accessed through an interface.

19. The system of claim 18, wherein the service provides application services to a second application formed of a plurality of dynamic distributed objects.
